(19) United States
(12) Patent Application Publication
(10) Pub. No.: US 2019/0061417 A1
(43) Pub. Date: Feb. 28, 2019

(54) Device for Cleaning a Paint Roller Cover

(71) Applicant: Roller Ready, LLC, Fort Wayne, IN (US)

(72) Inventor: Brian Robertson, Fort Wayne, IN (US)

(21) Appl. No.: 16/109,244

(22) Filed: Aug. 22, 2018

Related U.S. Application Data
(60) Provisional application No. 62/548,724, filed on Aug. 22, 2017.

(51) Int. Cl. B44D 3/00

(52) U.S. Cl. CPC B44D 3/006; B05C 17/0245

(57) ABSTRACT

A device for cleaning a paint roller cover by scraping or immersion, generally comprising an attachment member comprising a distal end and a proximal end and a cylindrical member comprising a cylinder base and a cylinder end. The cylindrical member is insertable into a paint roller cover, the proximal end of the attachment member is rigidly connected to the cylindrical member at the cylinder base, and the attachment member is configured to attach the device to a tool providing rotation about the central longitudinal axis of the device.

### CROSS-REFERENCES TO RELATED APPLICATIONS

This Application is a nonprovisional of, and incorporates in its entirety, U.S. Application No. 62/548,724, Device for Cleaning a Paint Roller Cover, filed on Aug. 22, 2017. This application is further related to a Patent Cooperation Treaty Application filed on the same day hereas, titled Device for Cleaning a Paint Roller Cover.

### STATEMENT REGARDING FEDERALLY SPONSORED RESEARCH OR DEVELOPMENT

Not applicable.

### BACKGROUND

Painting is a common task required for the maintenance, repair, improvement, or beautification of surfaces, most notably walls, ceilings, floors, trim, or furniture surfaces. Those skilled in the art of painting use a variety of tools to apply paint to surfaces. One common tool known to the art for rapidly painting relatively flat surfaces is a paint roller. Generally, a paint roller consists of a roller cover and a roller frame. A roller cover is a cylindrical, relatively rigid tube open on one end or both ends, comprising a substrate covered with a surface known to those skilled in the art as a nap. The nap is selected to absorb paint and then evenly apply the paint when the paint roller is rolled over a relatively flat surface. Common nap materials include foams, including rubber foams, and fabrics, including pile fabrics. Roller covers are offered in a variety of different lengths.

While some roller covers may be significantly longer, common lengths for short roller covers include two inches, four inches, and six inches. Some common roller covers that are short in length have an inner diameter of 0.25 inches, and other common short roller covers may have an inner diameter of 0.75 inches. A roller frame is a structure, typically wire, with a handle at one end and a cylindrical shank at the other end sized to fit inside of a roller cover, retain it by friction fit, and allow the roller cover to rotate and spin when in use. Typically, a roller frame will have an approximately ninety-degree bend between the handle end and the cylindrical shank end for ease of use while painting. Roller frames generally include an integral or connected handle, and the cylindrical shank is provided in diameters and lengths corresponding to the common diameters and lengths of roller covers. To use a paint roller, a painter slides the roller cover over a correspondingly-sized roller frame, wets the roller cover with paint, and, using the roller frame, rolls the roller cover along a surface to be painted.

During use of a paint roller, paint typically penetrates deeply into the nap. Although roller covers are commonly designed to be reusable, they are difficult to clean sufficiently to make them desirable for re-use. Roller covers are particularly difficult to clean thoroughly enough to allow their subsequent use to apply different colors, finishes, or styles of paint without an undesirable mixing between the earlier- and later-applied products, or without dried residual paint degrading the consistency of application of new paint from the nap. Methods of cleaning a roller cover known to the art include scraping the nap along an edge, such as an edge of a paint can. Due to the roller cover's cylindrical shape, the roller cover must be rotated slightly after each section is scraped to enable cleaning of the entire nap. Once the entire nap has been scraped, it is typically still necessary to wash and scrub the roller cover to remove residual paint. The roller cover is then allowed to air dry. This known method of cleaning paint rollers has a number of disadvantages. Most notably, it is messy and unreasonably time consuming, particularly for a professional painter.

Another method of roller cover cleaning known to the art is to submerge the roller cover in a cleaning solution, typically water, and to move, spin, or agitate the roller cover while submerged to cause the removal of paint. This method of cleaning is, like scraping, unduly time consuming to perform by hand. Further, this method is typically not effective to remove paint from a roller cover without undue effort unless the scraping method described above is first used to remove excess paint from the nap. This process may have to be repeated several times before the roller cover is sufficiently clean for re-use.

Devices known to the art, such as hand-operated spinners, exist to aid with the rotation or agitation of a submerged roller cover for cleaning. However, these devices are typically not compatible with short paint roller covers, especially those rollers with small inner diameters. Also, these devices are relatively ineffective and do not spin or agitate the roller cover at sufficient speeds to offer any meaningful advantage in time or effort compared to hand rotation. It is also known to the art to use a power drill and an adapter to spin a roller cover during submersion. One adapter used for cleaning roller covers consists of a rod receivable by a motorized drill, the rod attached to a square tuning fork-shaped member, where the tines of the fork are flexible and are spaced to correspond to the interior diameter of a roller cover. A roller cover can be slid over the tines, forcing the tines to flex inward, and the device can be attached to a drill to allow rapid rotation of the device. This adapter suffers a number of disadvantages. Most notably, adapters of this type cannot easily be used for shorter roller covers, which commonly have inner diameters of only 0.25 inches or 0.75 inches, due to the large overall length and width of the fork and tines and the limited space in which the tines can sufficiently flex within such a roller cover.

Additionally, over time, the ability of these adapters to securely retain a roller cover during use will degrade as the tines weaken from repeated flexion. For example, due to the design characteristics of the flexion of the tines, these adapters inherently provide little to no support to the interior of a roller cover at the end opposite the cylinder base of the forks, and further provide little to no support to areas of the interior of the roller cover not directly adjacent to a tine regardless of where located along the length of the roller cover. After repeated uses, this lack of support will likely cause degradation or damage to the unsupported portions of the roller cover, making these adapters unsuitable for use in connection with the scraping method of cleaning. Further, the design of these adapters permits significant slippage of a roller cover when the device is in use, such slippage being particularly likely if the device is used with a drill at high speed, and such slippage being likely to lead to abrasion or damage to the interior of the roller cover. Such slippage would further reduce the efficiency of the device for cleaning using the submersion method.

Desirable traits for an improved device for cleaning roller covers would include increased durability for repeated use, support to greater portions of the interior of a paint roller cover, and compatibility with short roller covers, especially those roller covers with a small inner diameter.

### SUMMARY

The present invention is directed to an improved device to assist with cleaning a roller cover by scraping or by submersion. Embodiments of the present invention offer greater durability in the face of repeated use, will hold a paint roller more securely during high-speed rotation, and will provide substantially greater support to the interior surface of a paint roller cover, particularly such roller covers with small inner diameters, than devices known to the prior art. Generally, embodiments of the present invention comprise an attachment member and a rigid cylindrical member. The attachment member comprises a proximal end and a distal end, and the cylindrical member comprises a cylinder base and a cylinder end and has an outer diameter approximately equal to the inner diameter of a paint roller cover. The attachment member comprises a shank at its distal end and is connected at its proximal end to the cylindrical member at the cylinder base.

### BRIEF DESCRIPTION OF THE DRAWINGS

These and other features, aspects, and advantages of the present invention will become better understood with regard to the following description and accompanying drawings, where:

FIG. 1 shows a side view of a preferred embodiment of the present invention;

FIG. 2 shows a perspective view of a preferred embodiment of the present invention;

FIG. 3 shows a perspective view of a preferred embodiment of the present invention;

FIG. 4 shows a front view of a preferred embodiment of the present invention;

FIG. 5 shows a rear view of a preferred embodiment of the present invention;

FIG. 6 shows a side view of a second embodiment of the present invention;

FIG. 7 shows a perspective view of a second embodiment of the present invention;

FIG. 8 shows a perspective view of a second embodiment of the present invention;

FIG. 9 shows a front view of a preferred second of the present invention; and

FIG. 10 shows a rear view of a preferred second of the present invention.

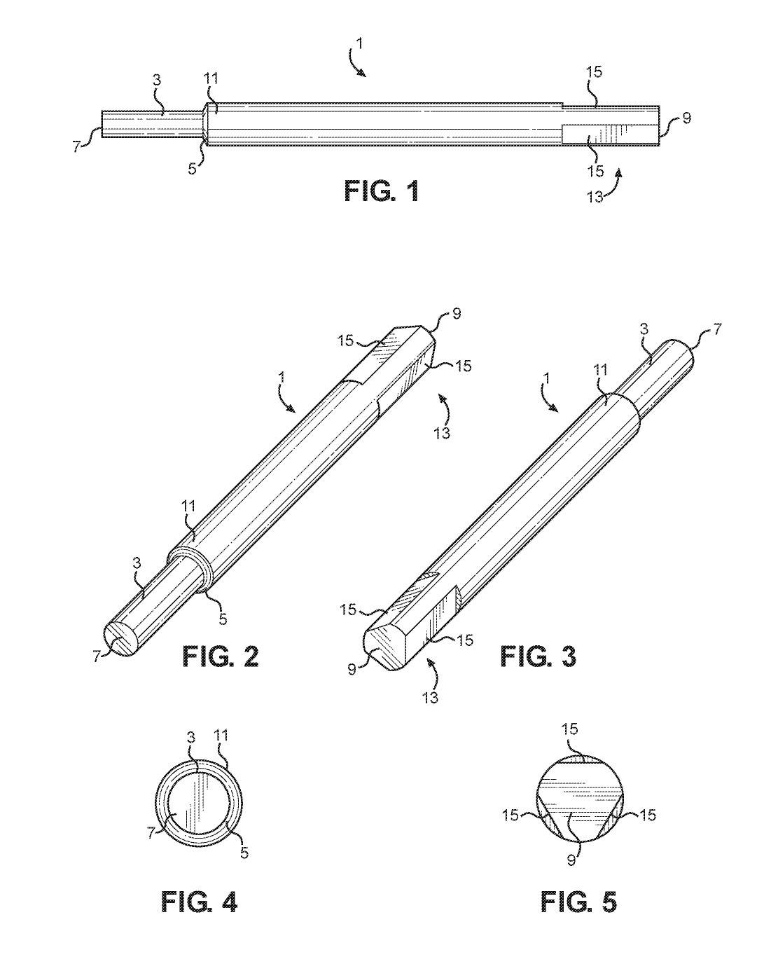

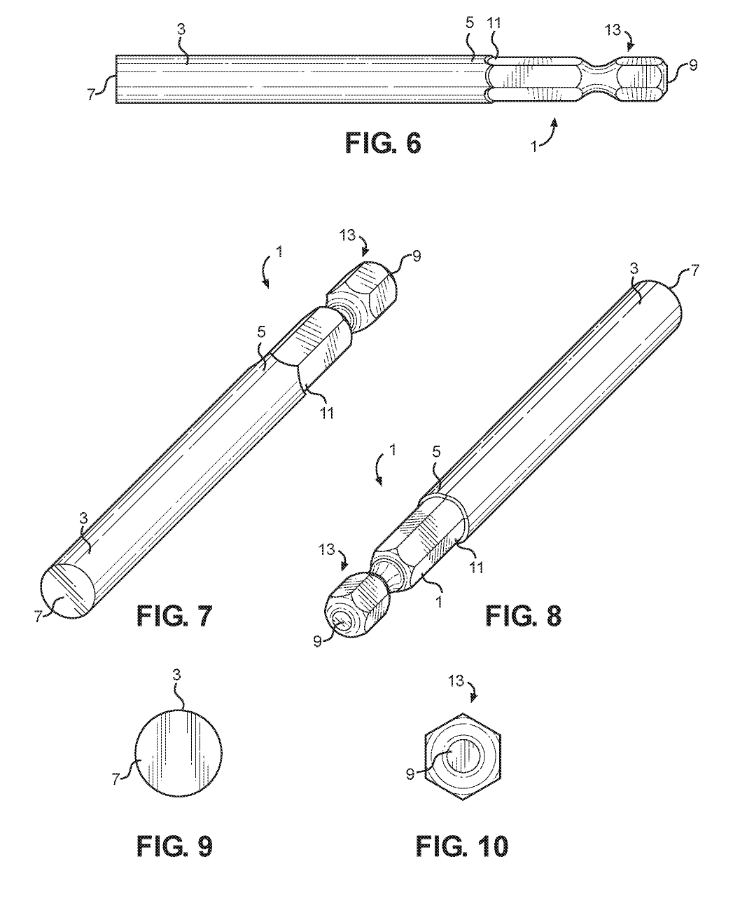

### DETAILED DESCRIPTION

Embodiments of the present invention are directed to an improved device for cleaning a paint roller cover by scraping or immersion. The present invention provides a number of advantages compared to devices known to the prior art. Specifically, embodiments of the present invention provide a device for securing and attaching a paint roller cover to a drill, permitting high-speed rotation of the roller cover without significant slippage, abrasion, or damage to the interior of the roller cover, allowing water or other fluid to reach both the interior and exterior of the roller cover during submersion, and affording substantial support to the interior of a roller cover, including, optionally, support along substantially all of the roller cover's length, such that the roller cover can be cleaned by either submersion or scraping with reduced risks of damage, abrasion, or degradation from lack of interior support.

In a preferred embodiment, the device of the present invention comprises an attachment member (1) and a cylindrical member (3). The cylindrical member (3) comprises a substantially solid surface, and the cylindrical member (3) further comprises a cylinder base (5) and a cylinder end (7). The attachment member (1) comprises a distal end (9) and a proximal end (11), and the proximal end (11) of the attachment member (1) is rigidly connected to the cylindrical member (3) at the cylinder base (5). In a preferred embodiment, the device of the present invention is made of a material that is relatively light, rigid, and corrosion resistant. Suitable preferred materials include metals and metal alloys, woods, laminate surfaces, and rigid plastics and polymers. Most preferably, the device is made of aluminum.

An attachment member (1) of the present invention comprises a shank (13) configured to attach the device to a tool providing rotation about the central longitudinal axis of the device, such as a power drill. In the preferred embodiment, the attachment member (1) protrudes substantially orthogonally from the cylinder base (5), with a shape, size, and profile suitable for insertion into the chuck of a handheld drill. As would be appreciated by one skilled in the art, a variety of shapes, sizes, and profiles of shank (13) may be used. For example, suitable profiles include round, square, rectangular, hexagonal, and octagonal. In a preferred embodiment, the shank (13) is located at the distal end (9) of the attachment member (1) and comprises three flat portions (15) that may be cut or milled into the distal end (9) of the attachment member (1) to form the shank (13). The three flat portions (15) of the shank (13) are equidistantly spaced apart about the outer diameter of the attachment member (1) distal end (9), and each flat portion (15) is preferably equal to approximately 0.290 inches wide and approximately 1.000 inches long, extending longitudinally inward along the outer diameter of the distal end (9) toward the proximal end (11) of the attachment member (1). In other embodiments, the attachment member (1) may alternatively comprise a hexagonal shank (13).

The attachment member (1) is also preferably tapered such that the outer diameter of the attachment member (1) distal end (9) is larger than the outer diameter of the attachment member (1) proximal end (11). This allows for easier insertion of the cylindrical member (3) and optionally the proximal end (11) of the attachment member (1) into a paint roller cover with a small inner diameter, such as a roller cover with a diameter of 0.25 inches. In a preferred embodiment, the distal end (9) of the attachment member (1) has an outer diameter approximately equal to 0.312 inches. The total length of the preferred embodiment is equal to approximately 4.000 inches, comprising an attachment member (1) equal to approximately 3.300 inches in length and a cylindrical member (3) equal to approximately 0.700 in length. Preferably, the length of the portion of the attachment member (1) that is tapered is equal to approximately 0.945 inches, such that the tapered portion of the attachment member (1) does not intersect with the shank (13) at the distal end (9) of the attachment member (1).

The cylinder base (5) of the present invention is substantially coaxial to the attachment member (1), supporting the cylindrical member (3) and rigidly attached to both the proximal end (11) of the attachment member (1) and to the cylindrical member (3). In a preferred embodiment, the attachment member (1), cylinder base (5), and cylindrical member (3) are integral to each other. As would be appreciated by one skilled in the art, however, the cylinder base (5) may be integral to only the cylindrical member (3), or may comprise a component separate from, but connected to, the cylindrical member (3) and the attachment member (1). The cylinder base (5) is sufficiently rigid to support the cylindrical member (3) and maintain rigid connection with the attachment member (1) proximal end (11). The cylinder base (5) may be any size or shape suitable to support a cylindrical member (3) with an outer diameter substantially equal to the inner diameter of a paint roller. In a preferred embodiment, the cylinder base (5) comprises a generally disc-shaped platform integral to both the cylindrical member (3) and the attachment member (1).

A cylindrical member (3) of the present invention comprises a substantially solid cylinder body connected to the cylinder base (5) and comprises sufficient rigidity to support a paint roller cover. A cylindrical member (3) may comprise a smooth outer surface, or it may comprise a roughened outer surface. A cylindrical member (3) of embodiments of the present invention preferably has an outer diameter approximately equal to the inner diameters of commercially available roller covers. A preferred cylindrical member (3) outer diameter size is approximately 0.256 inches, slightly larger than the common 0.25 inch inner diameter of commercially available roller covers to allow for sufficient friction fit between the cylindrical member (3) and a roller cover. A cylindrical member (3) according to embodiments of the present invention may be of any length suitable to accommodate the length of a commercially available roller cover. Although the cylindrical member (3) may be of any length within the spirit and teaching of the present invention, the preferred cylindrical member (3) length is equal to approximately 0.700 inches. Alternative cylindrical member (3) lengths include one or more of: approximately two inches, approximately four inches, and approximately six inches, as these are the most common lengths of roller covers that comprise an inner diameter of 0.25 inches. In one embodiment, the cylindrical member (3) has a length of approximately 2.07 inches to allow the cylindrical member (3) to sufficiently support the full length of a common commercially available two-inch roller cover. As would be appreciated by one skilled in the art, a cylindrical member (3) can be sized to accommodate a specific length of paint roller cover or, alternatively, a cylindrical member (3) of any length, particularly one of the preferred lengths noted above, can be used in conjunction with a paint roller cover of any common length. For example, an embodiment of the present invention with a cylindrical member (3) of approximately two inches may be used in conjunction with a four-inch paint roller cover, in which case the device would support the interior of the paint roller cover along the substantial entirety of both its circumference and length. Alternatively, that same embodiment of the device could be used to support a paint roller cover longer than four inches, in which case the device would support the interior of the paint roller cover along the substantial entirety of its circumference for a portion of its length.

A cylindrical member (3) according to the present invention may have the same outer diameter at all points along its length. However, the cylindrical member (3) is preferably tapered such that its outer diameter is narrower at the portion of the cylindrical member (3) immediately adjacent to the cylinder end (7) than it is at the portion of the cylindrical member (3) immediately adjacent to the cylinder base (5). Such a taper permits a roller cover to slide onto the cylindrical member (3) without harmfully bending, crushing, or deflecting the substrate of the roller cover, while also allowing a sufficiently tight fit between the cylindrical member (3) and the roller cover to secure the roller cover and prevent undue slippage during high speed rotation. In a preferred embodiment, the taper is slight, such that while the roller cover is secured to the device more tightly near the cylinder base (5) than it is near the cylinder end (7), the entire length of the cylindrical member (3) substantially supports the interior of the roller cover. In a most preferred embodiment, the outer diameter of the cylindrical member (3) immediately adjacent to the cylinder base (5) is equal to approximately 0.256 inches. The taper is continuous and the difference between the outer diameter of the portion of the cylindrical member (3) immediately adjacent to the cylinder end (7) and the portion of the cylindrical member (3) immediately adjacent to the cylinder base (5) is equal to approximately 0.046 inches, such that the outer diameter of the cylindrical member (3) immediately adjacent to the cylinder end (7) is equal to approximately 0.210 inches.

A device according to the present invention may be used, in conjunction with a power drill and a roller cover, to clean and dry a roller cover through a submersion method. Submersion cleaning through use of this device is accomplished by attaching the attaching member of the device to a power drill, aligning an interior central bore of a roller cover with a correspondingly-sized cylindrical member (3) of the present invention, sliding the roller cover over the cylindrical member (3) a desired distance, submerging the roller cover and device into water or other cleaning fluid, and actuating the power drill to rotate the roller cover at relatively high speed. Water or other cleaning fluid will contact and clean the roller cover's nap directly. One or more submersions in one or more containers of water or other selected cleaning fluid may be employed to clean a roller cover. When the roller cover has reached the desired degree of cleanliness, the device may be removed from submersion and the drill again activated. In open air, the relatively high speed rotation of the device will squeeze water out of the roller cover through centrifugal force, thus drying the roller cover.

Because of the substantial support provided to the interior of a roller cover along the entire length and circumference of the cylindrical member (3), a device according to embodiments of the present invention may also be used to assist with cleaning and drying a roller cover through a scraping method. Scrape cleaning through use of this device is accomplished by attaching the attaching member of the device to a power drill, aligning the interior central bore of a roller cover with a correspondingly-sized cylindrical member (3) of the present invention, sliding the roller cover over the cylindrical member (3) a desired distance, and, using a common handheld paint scraper, sliding the scraper along the roller cover while slowly rotating the roller cover by activating the power drill. Alternately, as would be appreciated by one skilled in the art, a roller cover may be pre-cleaned or cleaned by mounting a roller cover to the device, attaching the device to a power drill, and actuating the drill to cause paint to be squeezed from the roller cover through centrifugal force alone. After scraping, a roller cover may optionally be further cleaned by submersion.

Although the present invention has been described in considerable detail with reference to certain preferred versions thereof, other versions are possible. For example, materials, shapes, sized, or configurations other than those described in detail herein may be used for the versions of this invention. Therefore, the spirit and scope of the claims should not be limited to the description of the preferred versions described herein.

What is claimed is:

1. A device for cleaning a paint roller cover by scraping or by submersion, said device comprising an attachment member and a rigid cylindrical member, said attachment member comprising a proximal end and a distal end, and said cylindrical member comprising a cylinder base and a cylinder end, wherein said cylindrical member further comprises an outer diameter approximately equal to the inner diameter of a paint roller cover, and wherein said proximal end of the attachment member is rigidly connected to said cylindrical member at said cylinder base.

2. The device of claim 1, wherein said attachment member and said cylindrical member support the inner surface of a paint roller cover along substantially the entire circumference and length of said cylindrical member.

3. The device of claim 2, wherein said distal end of the attachment member comprises an outer diameter approximately equal to 0.312 inches.

4. The device of claim 3, wherein said attachment member is tapered such that the outer diameter of said distal end of the attachment member is larger than the outer diameter of said proximal end of the attachment member.

5. The device of claim 2, wherein the outer diameter of a portion of said cylindrical member immediately adjacent to said cylinder base is equal to approximately 0.256 inches.

6. The device of claim 5, wherein said cylindrical member is tapered such that the outer diameter of the portion of said cylindrical member adjacent to said cylinder base is larger than the outer diameter of a portion of said cylindrical member adjacent to said cylinder end.

7. The device of claim 6, wherein said taper is substantially continuous along the length of said cylindrical member.

8. The device of claim 7, wherein the difference between the outer diameter of the portion of said cylindrical member immediately adjacent to said cylinder end and the outer diameter of the portion of said cylindrical member immediately adjacent to said cylinder base is equal to approximately 0.046 inches.

9. The device of claim 2, wherein said cylindrical member has a length approximately equal to 0.700 inches.

10. The device of claim 2, wherein said cylindrical member has a length approximately equal to a length of a paint roller cover.

11. The device of claim 10, wherein said cylindrical member has a length equal selected from the group consisting of: approximately two inches, approximately four inches, and approximately six inches.

12. The device of claim 11, wherein said cylindrical member has a length of approximately 2.07 inches.

13. The device of claim 1, wherein said distal end of the attachment member comprises a shank with a profile suitable for connection to a drill chuck.

14. The device of claim 13, wherein said shank comprises three flat portions equidistantly spaced about the outer diameter of said distal end of the attachment member and extending longitudinally inward from said distal end of the attachment member.

15. The device of claim 14, wherein said three flat portions are each approximately 0.290 inches wide and approximately 1.000 inches long.

16. The device of claim 13, wherein said attachment member comprises a hexagonal shank.

17. The device of claim 1, wherein the total length of the device is equal to approximately 4.000 inches.
